(19) United States
(12) Patent Application Publication
(10) Pub. No.: US 2010/0108431 A1
(43) Pub. Date: May 6, 2010

(54) STEERING SYSTEM

(75) Inventors: Katsumi Makuta, Oyama-shi (JP); Nobuhisa Honda, Oyama-shi (JP); Keisuke Taka, Oyama-shi (JP)

Correspondence Address: EDWARDS ANGELL PALMER & DODGE LLP, P.O. BOX 55874, BOSTON, MA, 02205, US

(73) Assignee: KOMATSU LTD, TOKYO (JP)

(21) Appl. No.: 12/451,904

(22) PCT Filed: Apr. 9, 2008
(86) PCT No.: PCT/JP2008/056994

§ 371 Date: Dec. 4, 2009

(30) Foreign Application Priority Data
Jun. 8, 2007 (JP) 2007152672

(51) Int. Cl. B62D 5/06

(52) U.S. Cl. 180/422

(57) ABSTRACT

A steering system that with a directional control valve 200 switchingly operating based on a pilot flow rate supplied from a steering motor unit 300 when a steering handle 330 is manipulated, that steers a vehicle 100 according to manipulation of the steering handle 330 by controlling a supply of pressure oil to cylinder actuators C1 and C2 through the directional control valve 200, includes an electromagnetic valve unit 600a, 600b that supplies a correction pilot pressure to the directional control valve 200 so as to correct a pilot pressure generated by the pilot flow rate from the steering motor unit 300 when a command signal is given.

### TECHNICAL FIELD

The present invention relates to a steering system suitable for vehicles such as a construction machine.

### BACKGROUND ART

An example of steering systems applied to vehicles such as a construction machine is a steering system described in Patent Document 1. In this steering system, when a steering handle is manipulated, a pilot flow rate is supplied from a steering motor unit to a directional control valve, and the directional control valve is switchingly operated based on the manipulation of the steering handle. When the directional control valve is switchingly operated, directions of pressure oil supply from a steering pump to a steering actuator are switched, and the vehicle is steered according to the manipulation of the steering handle.

In this type of steering system, a situation in which the operation of the steering actuator does not match the manipulation of the steering handle (hereinafter, “knob displacement”) may be caused by various factors such as an internal oil leakage and a disturbance. When such a knob displacement occurs, the vehicle does not travel according to intensions of an operator, which lowers operability of the applied vehicle.

Thus, in the technique described in Patent Document 1, a corrective hydraulic circuit including an electromagnetic valve unit is interposed between the directional control valve and the steering actuator. That is, in the technique described in Patent Document 1, when the knob displacement occurs, the electromagnetic valve unit of the corrective hydraulic circuit is actuated to supply a corrective pressure oil to the steering actuator, thereby correcting the knob displacement.

Patent Document 1: Japanese Patent Application Laid-open No. 2005-297924

### DISCLOSURE OF INVENTION

### Problem to be Solved by the Invention

In the technique described in Patent Document 1, the corrective pressure oil is supplied to the steering actuator. Thus, the correction is enabled when the operation of the steering actuator is smaller or later than the manipulation of the steering handle. However, when the operation of the steering actuator is larger or earlier than the manipulation of the steering handle, the correction is difficult.

The present invention has been achieved in view of the above circumstances, and an object of the present invention is to provide a steering system capable of constantly improving operability of a vehicle applied with the steering system.

### Means for Solving Problem

According to an aspect of the present invention, a steering system with a directional control valve switchingly operating based on a pilot flow rate supplied from a steering motor unit when a steering handle is manipulated, that steers a vehicle according to a manipulation of the steering handle by controlling a supply of pressure oil to a steering actuator through the directional control valve includes an electromagnetic valve that supplies a correction pilot pressure to the directional control valve so as to correct a pilot pressure generated by the pilot flow rate from the steering motor unit when a command signal is given.

Advantageously, in the steering system, the steering actuator is a cylinder actuator that operates to extend or retract according to a direction of pressure oil supply, the directional control valve includes a spool being disposed movably relative to the sleeve and changes the direction of the pressure oil supply to the steering actuator according to a movement direction of the spool, and the spool includes a pilot-pressure receiving surface on which the pilot pressure generated by the pilot flow rate from the steering motor unit is applied, and a correction-pilot-pressure receiving surface on which the correction pilot pressure from the electromagnetic valve is applied.

### EFFECT OF THE INVENTION

According to the present invention, there are provided the electromagnetic valve units that supply the correction pilot pressure to the directional control valve in a manner to correct the pilot pressure generated by the pilot flow rate from the steering motor unit when a command signal is given, and thus, when the correction pilot pressure is supplied from the electromagnetic valve units, the directional control valve can be operated. Accordingly, when the operation of the steering actuator is smaller or later than the manipulation of the steering handle, this can be corrected by supplying the correction pilot pressure in the same direction as that of the pilot pressure. When the operation of the steering actuator is larger or earlier, this can be corrected by supplying the correction pilot pressure in a direction opposite to that of the pilot pressure. As a result, it becomes possible to drive the steering actuator based on the manipulation of the steering handle, thereby enabling improvement of the operability of the applied vehicle.

### BRIEF DESCRIPTION OF DRAWINGS

FIG. 1 is a circuit diagram of a steering system according to an embodiment of the present invention.

FIG. 2 is a plan view for conceptually depicting a vehicle applied with the steering system shown in FIG. 1.

FIG. 3 is an enlarged view of a directional control valve shown in FIG. 1.

FIG. 4 is a perspective view of relevant parts for conceptually depicting pilot-pressure receiving surfaces and correction-pilot-pressure receiving surfaces of the directional control valve shown in FIG. 1.

FIG. 5 is a flowchart of a correcting process performed by a controller shown in FIG. 1.

### EXPLANATIONS OF LETTERS OR NUMERALS

200 directional control valve
201 sleeve
202a, 202b actuator port
203 input port
204a, 204b drain port
205 spool
206 neutral spring
207a, 207b correction-pilot-pressure receiving surface
208a, 208b pilot-pressure receiving surface
215a, 215b communication port
216 second short-circuit oil passage
220 first short-circuit oil passage
221 fixed throttle valve
230 valve driving unit
231a first pilot-pressure chamber
231b second pilot-pressure chamber
232a, 232b correction-pilot-pressure chamber
300 steering motor unit
310 steering motor
320 steering valve
321 pilot input port
322 pilot drain port
323a, 323b motor port
324a, 324b pilot output port
325 centering spring
330 steering handle
331 handle shaft
400 steering pump
500 oil tank
600a, 600b electromagnetic valve
602a first correction-pilot-pressure output passage
602b second correction-pilot-pressure output passage
700 controller
C1, C2 cylinder actuator for steering

### BEST MODE(S) FOR CARRYING OUT THE INVENTION

Exemplary embodiments of a steering system according to the present invention will be explained below in detail with reference to the accompanying drawings.

### EMBODIMENTS

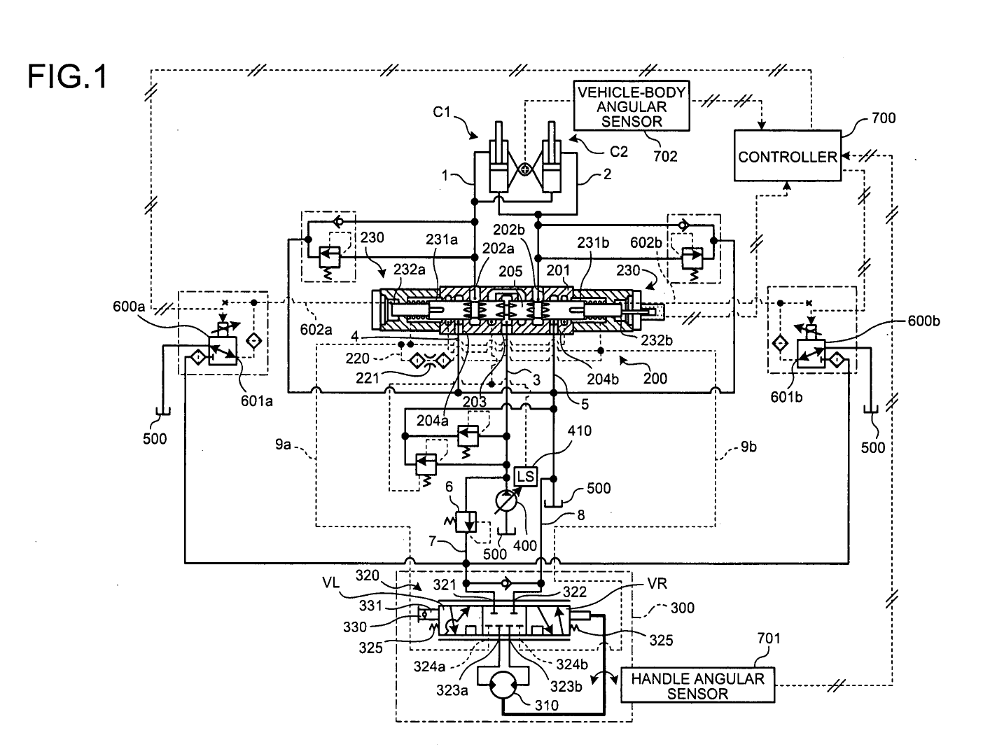

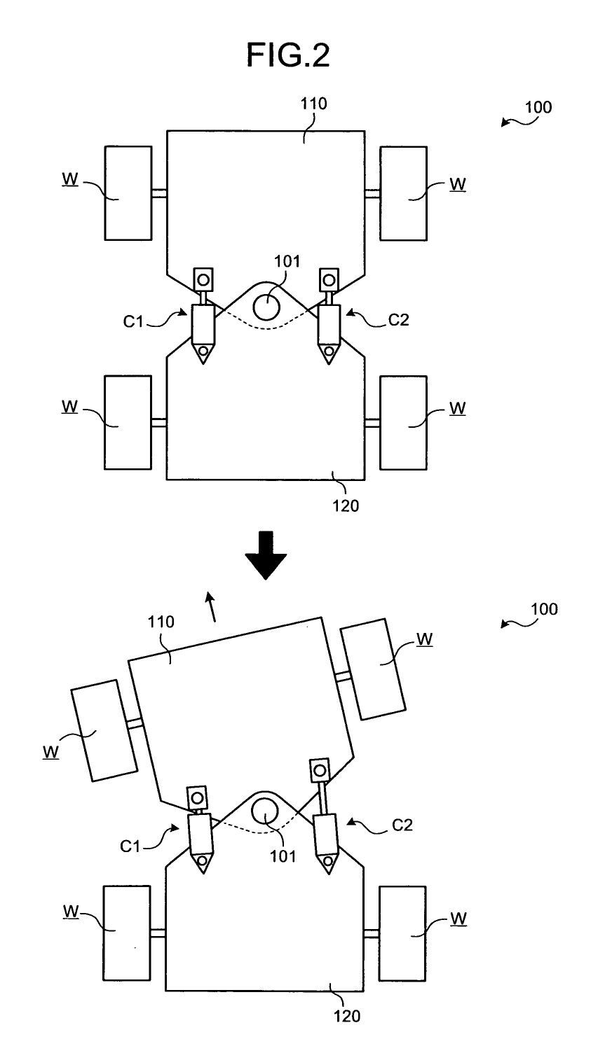

FIG. 1 is a circuit diagram of a steering system according to an embodiment of the present invention. The steering system exemplified herein is applied to a vehicle 100 used as a construction machine such as a wheel loader and a dump truck. Particularly, in the present embodiment, as shown in FIG. 2, the steering system is applied to the vehicle 100 which includes a linking pin 101 along a vertical axis at the center portion thereof and which is steered by placing a forward vehicle-body unit 110 and a backward vehicle-body unit 120 to form a bend with respect to each other about the linking pin 101. The forward vehicle-body unit 110 and the backward vehicle-body unit 120 each include a pair of left and right wheels W, and are swingably linked to each other via the linking pin 101.

Between the forward vehicle-body unit 110 and the backward vehicle-body unit 120, cylinder actuators C1 and C2 for steering are arranged at both sides across the linking pin 101. Each of the cylinder actuators C1 and C2 has one end, for example, the proximal end of a cylinder body, which is swingably supported about a vertical axis at a portion that is the front end of the backward vehicle-body unit 120. The other end of each of the cylinder actuators C1 and C2, for example, the distal end of an actuation rod, is swingably supported about a vertical axis at a portion that is the rear end of the forward vehicle-body unit 110.

The cylinder actuators C1 and C2, when holding a state of a mutually neutral position as shown in the upper portion of FIG. 2, for example, can move straight the vehicle 100 by placing the forward vehicle-body unit 110 and the backward vehicle-body unit 120 in a straight line. When the cylinder actuator C1 is actuated to degenerate whereas the other cylinder actuator C2 is actuated to expand, as shown in the lower portion of FIG. 2, for example, the forward vehicle-body unit 110 comes to a state of being bent to the left relative to the backward vehicle-body unit 120. Accordingly, in this state, the vehicle 100 can be moved in the left direction in which the forward vehicle-body unit 110 is oriented. When the vehicle 100 is to be moved to the right, it suffices to operate the cylinder actuators C1 and C2 in the opposite direction. In the present embodiment, as shown in FIG. 1, head-side pressure chambers and rod-side pressure chambers are alternately connected by a pair of connection oil passages 1 and 2 so that the cylinder actuator C1 and the other cylinder actuator C2 are synchronized to operate in the opposite directions. Specifically, the rod-side pressure chamber of the first cylinder actuator C1 located on the left side in FIG. 1 and the head-side pressure chamber of the second cylinder actuator C2 located on the right side in FIG. 1 are connected to each other by the first connection oil passage 1. Similarly, the head-side pressure chamber of the first cylinder actuator C1 and the rod-side pressure chamber of the second cylinder actuator C2 are connected to each other by the second connection oil passage 2.

The steering system applied to the vehicle 100 includes a directional control valve 200, a steering motor unit 300, and a steering pump 400.

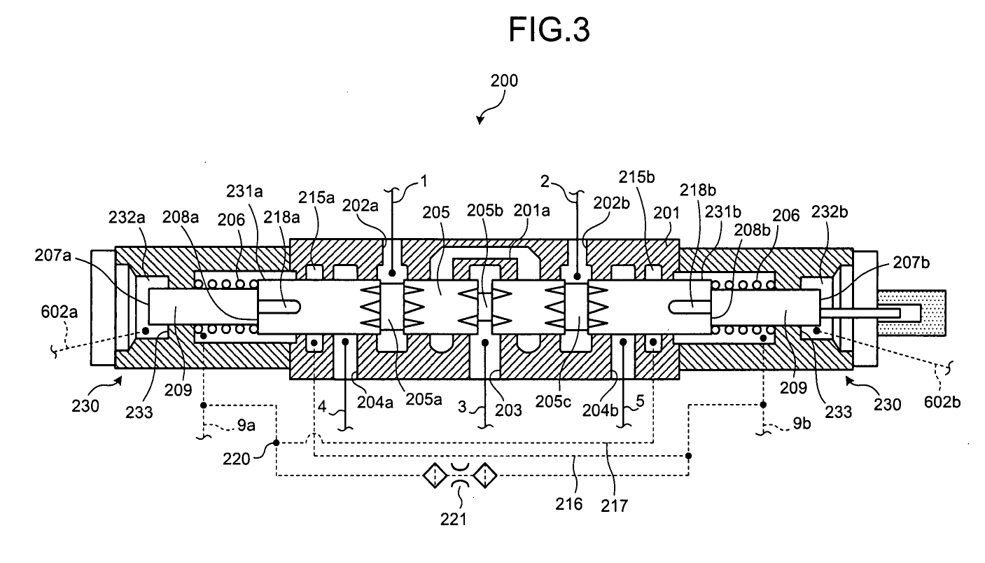

The directional control valve 200 includes, as shown in FIG. 3, a sleeve 201 arranged with a pair of actuator ports 202a and 202b, an input port 203, and a pair of drain ports 204a and 204b, and also includes a spool 205 movably arranged inside the sleeve 201. In the directional control valve 200, when the position of the spool 205 relative to the sleeve 201 is changed, connecting manners of the pair of actuator ports 202a and 202b, the input port 203, and the pair of drain ports 204a and 204b can be changed. The actuator ports 202a and 202b of the directional control valve 200 are individually connected to the connection oil passages 1 and 2 of the cylinder actuators C1 and C2. Specifically, the first actuator port 202a located on the left side in FIGS. 1 and 3 is connected to the first connection oil passage 1 whereas the second actuator port 202b located on the right side in FIGS. 1 and 3 is connected to the second connection oil passage 2. The input port 203 is connected to a discharge outlet of the steering pump 400 through a main supply-oil passage 3. The drain ports 204a and 204b are connected to an oil tank 500 through drain oil passages 4 and 5, respectively.

The directional control valve 200 is normally in a neutral state by a spring force of neutral springs 206, and the pair of actuator ports 202a and 202b, the input port 203, and the pair of drain ports 204a and 204b are all held in closed states.

When the spool 205 is moved from this neutral state to the left side relative to the sleeve 201 in FIGS. 1 and 3, for example, the first actuator port 202a and the first drain port 204a located on the left side in FIG. 1 establish communication with each other by a first communication oil groove 205a arranged in the spool 205. At the same time, by a second communication oil groove 205b and a third communication oil groove 205c arranged in the spool 205, the second actuator port 202b and the input port 203 establish communication with each other via an in-valve oil conduit 201a of the sleeve 201. Accordingly, when the steering pump 400 is driven, a pressure oil supplied through the main supply-oil passage 3 to the input port 203 is passed through the second communication oil groove 205b, the in-valve oil conduit 201a, and the third communication oil groove 205c to be fed to the second actuator port 202b, and further, the pressure oil is supplied to the head-side pressure chamber of the first cylinder actuator C1 and the rod-side pressure chamber of the second cylinder actuator C2, respectively, from the second actuator port 202b through the second connection oil passage 2. As a result, the first cylinder actuator C1 operates to expand whereas the second cylinder actuator C2 operates to degenerate. This brings the forward vehicle-body unit 110 in a state bent to the right relative to the backward vehicle-body unit 120, for example. In this way, the vehicle 100 can be moved toward the right. In the state described above, the pressure oil in the rod-side pressure chamber of the first cylinder actuator C1 and that in the head-side pressure chamber of the second cylinder actuator C2 are drained through the first connection oil passage 1, the first actuator port 202a, the first communication oil groove 205a, and the drain port 204a, into the oil tank 500.

On the other hand, when the spool 205 is moved from the neutral state to the right side relative to the sleeve 201 in FIG. 1, the first actuator port 202a and the input port 203 establish communication with each other by the first communication oil groove 205a and the second communication oil groove 205b in the spool 205. At the same time, by the third communication oil groove 205c of the spool 205, the second actuator port 202b and the second drain port 204b located on the right side in FIG. 1 establish communication with each other. Accordingly, when the steering pump 400 is driven, the pressure oil supplied through the main supply-oil passage 3 to the input port 203 is passed through the second communication oil groove 205b, the in-valve oil conduit 201a, and the first communication oil groove 205a to be supplied to the first actuator port 202a, and further, the pressure oil is supplied to the rod-side pressure chamber of the first cylinder actuator C1 and the head-side pressure chamber of the second cylinder actuator C2, respectively, from the first actuator port 202a through the first connection oil passage 1. As a result, the first cylinder actuator C1 operates to degenerate whereas the second cylinder actuator C2 operates to expand. This brings the forward vehicle-body unit 110 in a state bent to the left relative to the backward vehicle-body unit 120, for example. In this way, the vehicle 100 can be moved toward the left. In the state described above, the pressure oil in the head-side pressure chamber of the first cylinder actuator C1 and that in the rod-side pressure chamber of the second cylinder actuator C2 are drained through the second connection oil passage 2, the second actuator port 202b, the third communication oil groove 205c, and the drain port 204b, into the oil tank 500.

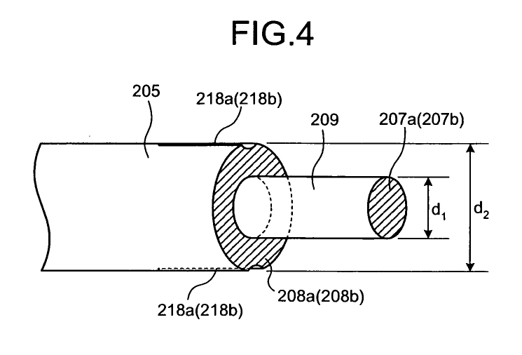

In the directional control valve 200 described above, the both ends of the spool 205 protrude from the sleeve 201, and correction-pilot-pressure receiving surfaces 207a and 207b and pilot-pressure receiving surfaces 208a and 208b are formed at the ends, respectively. As shown in FIG. 4, the correction-pilot-pressure receiving surfaces 207a and 207b are end surfaces of a small diameter unit 209 (ø=d1) forming columns at the both ends of the spool 205, and are formed in circles to have the same area. The pilot-pressure receiving surfaces 208a and 208b, which are larger in diameter than the small diameter unit 209, are end surfaces of the spool 205 (ø=d2>d1), and formed in a toroidal surface shape that is obtained by eliminating therefrom a center portion where the small diameter unit 209 extends. Also the pilot-pressure receiving surfaces 208a and 208b are configured to have the same area.

The steering motor unit 300 includes a steering motor 310 and a steering valve 320, as shown in FIG. 1. In the steering motor unit 300, when the steering valve 320 is switchingly operated via a steering handle 330, a connecting manner of a pilot input port 321, a pilot drain port 322, a pair of motor ports 323a and 323b, and a pair of pilot output ports 324a and 324b can be changed. The pilot input port 321 is connected to a discharge outlet of the steering pump 400 through a unit-supply oil passage 7 including a depressurizing valve 6. The depressurizing valve 6 depressurizes the pressure oil discharged from the steering pump 400 to a predetermined pressure, and feeds the depressurized pressure oil to the steering motor unit 300. There is not an absolute need of the depressurizing valve 6, and thus it is also possible to configure in such a manner that the pressure oil discharged from the steering pump 400 is directly fed to the steering motor unit 300.

The pilot drain port 322 is connected to the oil tank 500 through a pilot-drain oil passage 8. The pair of motor ports 323a and 323b is connected to a pair of distribution outlets arranged in the steering motor 310. The pair of pilot output ports 324a and 324b is connected to pilot-pressure-supply oil passages 9a and 9b, respectively. In FIG. 1, for the sake of convenience, a linear valve is shown as the steering valve 320. Practically, however, the steering valve 320 is configured as a two-layer rotary valve including a spool connected to a handle shaft 331 of the steering handle 330 and a sleeve that surrounds the spool. The steering motor 310 is configured to make rotation drive based on the manipulation of the steering handle 330.

In the steering motor unit 300, the steering valve 320 is normally in a neutral state due to a spring force of centering springs 325, and the pilot input port 321, the pilot drain port 322, the pair of motor ports 323a and 323b, and the pair of pilot output ports 324a and 324b are each held in a closed state.

When the steering handle 330 is manipulated to rotate from this neutral state in one direction by a predetermined amount, the steering valve 320 is moved to a first position VL located on the left side in FIG. 1, for example. Thereby, the pilot input port 321 and the first motor port 323a located on the left side in FIG. 1 establish communication. At the same time, the second motor port 323b and the second pilot output port 324b each located on the right side in FIG. 1 establish communication. Moreover, the steering motor 310 is rotated in one direction based on the manipulation of the steering handle 330. Accordingly, the pressure oil discharged from the steering motor 310 is output from the second pilot output port 324b. As a result, it becomes possible to supply a pilot flow rate through the second pilot-pressure-supply oil passage 9b connected to the second pilot output port 324b. In the state described above, the first pilot output port 324a located on the left side in FIG. 1 and the pilot drain port 322 establish communication, and thus the pressure oil in the first pilot-pressure-supply oil passage 9a connected to the first pilot output port 324a is drained into the oil tank 500.

The pressure oil output from the second pilot output port 324b to the second pilot-pressure-supply oil passage 9b is based on a manipulation amount for the steering handle 330. After outputting the pressure oil of a flow rate based on the manipulation amount for the steering handle 330, the steering valve 320 is restored to the neutral state by the centering springs 325, irrespective of the position of the steering handle 330. Accordingly, because the pilot input port 321, the pilot drain port 322, the pair of motor ports 323a and 323b, and the pair of pilot output ports 324a and 324b are each closed again, the supply of the pressure oil from the second pilot output port 324b is stopped.

On the other hand, when the steering handle 330 is manipulated to rotate from the neutral state in the other direction by a predetermined amount, the steering valve 320 is moved to a second position VR located on the right side in FIG. 1. Thereby, the pilot input port 321 and the second motor port 323b establish communication. At the same time, the first motor port 323a and the first pilot output port 324a establish communication. Moreover, the steering motor 310 is rotated in the other direction based on the manipulation of the steering handle 330. Accordingly, the pressure oil discharged from the steering motor 310 is output from the first pilot output port 324a, and as a result, the pilot flow rate can be supplied through the first pilot-pressure-supply oil passage 9a connected to the first pilot output port 324a. In the state described above, the second pilot output port 324b and the pilot drain port 322 establish communication, and as a result, the pressure oil in the second pilot-pressure-supply oil passage 9b connected to the second pilot output port 324b is drained into the oil tank 500.

Similarly to the case described above, the pressure oil output from the first pilot output port 324a to the first pilot-pressure-supply oil passage 9a based on a manipulation amount for the steering handle 330. After outputting the pressure oil based on the manipulation amount of the steering handle 330, the steering valve 320 is restored to the neutral state by the centering springs 325, irrespective of the position of the steering handle 330. Accordingly, because the pilot input port 321, the pilot drain port 322, the pair of motor ports 323a and 323b, and the pair of pilot output ports 324a and 324b are each closed again, the supply of the pressure oil from the first pilot output port 324a is stopped.

The steering pump 400 is a variable-displacement hydraulic pump. In the present embodiment, a hydraulic pump including a load-pressure-sensitive driving unit 410 that changes a displacement based on a load pressure during the supply of the pressure oil from the directional control valve 200 to the cylinder actuators C1 and C2 is applied as the steering pump 400. The load-pressure-sensitive circuit is not necessarily limited to the configuration above described. For example, it is also possible to configure the load-pressure-sensitive circuit including a fixed pump and an unload valve that is actuated based on a load pressure.

On the other hand, in the steering system, as shown in FIG. 3, a first short-circuit oil passage 220 and a pair of communication ports 215a and 215b are arranged in the directional control valve 200, and also, valve driving units 230 are provided at the both ends of the sleeve 20, respectively.

The first short-circuit oil passage 220 is formed at a portion extending from one end of the sleeve 201 to the other end thereof in the directional control valve 200, and has a fixed throttle valve 221 at an intermediate portion of the first short-circuit oil passage 220. As obviously shown in FIG. 1, one end of the first short-circuit oil passage 220 is connected to the first pilot-pressure-supply oil passage 9a and the other end thereof is connected to the second pilot-pressure-supply oil passage 9b. It is possible to supply a pressure oil from the steering motor unit 300 through the first pilot-pressure-supply oil passage 9a and the second pilot-pressure-supply oil passage 9b.

The communication ports 215a and 215b are arranged at the both ends of a portion facing the spool 205 in the sleeve 201. The second pilot-pressure-supply oil passage 9b is connected to the first communication port 215a located on the left side in FIGS. 1 and 3, whereas the first pilot-pressure-supply oil passage 9a is connected to the second communication port 215b located on the right side in FIGS. 1 and 3. In the pair of communication ports 215a and 215b, a second short-circuit oil passage 216 and a third short-circuit oil passage 217 are arranged as conceptually shown in FIG. 3. The second short-circuit oil passage 216 and the third short-circuit oil passage 217 both have an opening area larger than that of the first short-circuit oil passage 220. The second short-circuit oil passage 216 communicates between the communication port 215a and a second pilot-pressure chamber 231b whereas the third short-circuit oil passage 217 communicates between the communication port 215b and a first pilot-pressure chamber 231a. The both passages 216 and 217 can communicate between the first pilot-pressure chamber 231a and the second pilot-pressure chamber 231b through communicative notches 218a and 218b formed at the ends of the spool 205.

The communicative notches 218a and 218b are groove-shaped notches formed on the outer peripheral surface at the both ends of the spool 205 in a manner to run along an axial direction thereof. An end of the communicative notch 218a on the side that is close to the first pilot-pressure chamber 231a opens at a stepped portion between the spool 205 and the small diameter unit 209, and is always communicated with the first pilot-pressure chamber 231a. The other end of the communicative notch 218a on the side that is close to the communication port 215a is placed at a position spaced from the communication port 215a when the spool 205 is in a neutral state. The end is arranged at a position that enables to be communicated with the communication port 215a when the spool 205 moves by a predetermined amount to the right in FIGS. 1 and 3. The communicative notch 218a is formed in such a shape that an area communicated with the communication port 215a is progressively increased as a movement amount of the spool 205 to the right becomes greater. Likewise, an end of the communicative notch 218b on the side that is close to the second pilot-pressure chamber 231b opens at a stepped portion between the spool 205 and the small diameter unit 209, and is always communicated with the second pilot-pressure chamber 231b. The other end of the communicative notch 218b on the side that is close to the communication port 215b is placed at a position spaced from the communication port 215b when the spool 205 is in a neutral state. The end is arranged at a position that enables to be communicated with the communication port 215b when the spool 205 moves by a predetermined amount to the left in FIGS. 1 and 3. The communicative notch 218b is formed in such a shape that an area communicated with the communication port 215b is progressively increased as a movement amount of the spool 205 to the left becomes greater.

With cooperation of the second short-circuit oil passage 216, the third short-circuit oil passage 217, and the communicative notches 218a and 218b, neither the communicative notch 218a nor the communicative notch 218b are communicated with the communication ports 215a and 215b when the spool 205 is in a neutral state relative to the sleeve 201. Thus, the first pilot-pressure chamber 231a and the second pilot-pressure chamber 231b are held in a state isolated from each other. On the other hand, when the spool 205 is moved either to the left or right relative to the sleeve 201, when the spool 205 is moved to the right side in FIGS. 1 and 3, for example, the communicative notch 218a positioned on the left side is communicated with the communication port 215a. Accordingly, the first pilot-pressure chamber 231a and the second pilot-pressure chamber 231b are communicated with each other through the communicative notch 218a, the communication port 215a, and the second short-circuit oil passage 216. Likewise, when the spool 205 is moved to the left in FIGS. 1 and 3, the communicative notch 218b positioned on the right side is communicated with the communication port 215b, and thus the first pilot-pressure chamber 231a and the second pilot-pressure chamber 231b are communicated with each other through the communicative notch 218b, the communication port 215b, and the third short-circuit oil passage 217.

The valve driving unit 230 is for moving the spool 205 relative to the sleeve 201 of the directional control valve 200. The valve driving unit 230 includes the first pilot-pressure chamber 231a and a first correction-pilot-pressure chamber 232a at one end of the sleeve 201, and the second pilot-pressure chamber 231b and a second correction-pilot-pressure chamber 232b at the other end of the sleeve 201.

The first pilot-pressure chamber 231a and the second pilot-pressure chamber 231b house the pilot-pressure receiving surfaces 208a and 208b of the sleeve 201, respectively. The first pilot-pressure-supply oil passage 9a from the steering motor unit 300 is branch-connected to the first pilot-pressure chamber 231a whereas the second pilot-pressure-supply oil passage 9b from the steering motor unit 300 is branch-connected to the second pilot-pressure chamber 231b. In the first pilot-pressure chamber 231a and the second pilot-pressure chamber 231b, the neutral springs 206 are respectively housed.

The first correction-pilot-pressure chamber 232a and the second correction-pilot-pressure chamber 232b house the correction-pilot-pressure receiving surfaces 207a and 207b of the spool 205 at portions further outside the first pilot-pressure chamber 231a and the second pilot-pressure chamber 231b. The first pilot-pressure chamber 231a and the first correction-pilot-pressure chamber 232a adjacent to each other, and the second pilot-pressure chamber 231b and the second correction-pilot-pressure chamber 232b adjacent to each other are respectively separated by partition walls 233.

As shown in FIG. 1, the steering system further includes a pair of electromagnetic valve units 600a and 600b and a controller 700. When a command signal is respectively given thereto, the electromagnetic valve units 600a and 600b individually output pressure oils for applying correction pilot pressures corresponding to the command signal. The first electromagnetic valve unit 600a located on the left side in FIG. 1 has an output port 601a, which is connected via a first correction-pilot-pressure output passage 602a to the first correction-pilot-pressure chamber 232a whereas the second electromagnetic valve unit 600b located on the right side in FIG. 1 has an output port 601b, which is connected via a second correction-pilot-pressure output passage 602b to the second correction-pilot-pressure chamber 232b. Correction pilot pressures output from the electromagnetic valve units 600a and 600b are pressure oils that are supplied from the steering pump 400 through the unit-supply oil passage 7.

The controller 700 outputs the command signal to the electromagnetic valve units 600a and 600b based on a detection signal from a handle angular sensor 701 that detects a manipulated angle of the steering handle 330, and a detection signal from a vehicle-body angular sensor 702 that detects a vehicle body angle formed between the forward vehicle-body unit 110 and the backward vehicle-body unit 120. In the controller 700, manipulation amounts (handle angles) of the steering handle 330 and appropriate vehicle-body angles formed between the forward vehicle-body unit 110 and the backward vehicle-body unit 120 corresponding to the handle angles are previously stored in its own memory (not shown) in a mutually associated manner.

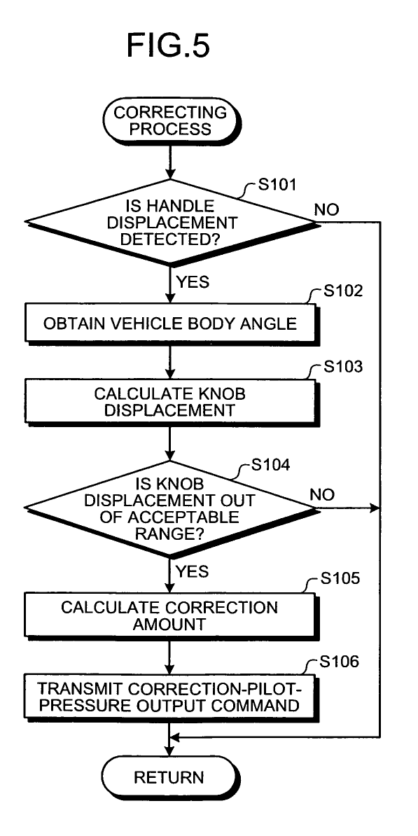

FIG. 5 is a flowchart of a correcting process performed by the controller 700 shown in FIG. 1. With appropriate reference to the flowchart, an operation of the steering system will be described below.

In the steering system configured as described above, when the steering handle 330 is held in a straight-ahead state, for example, the steering valve 320 of the steering motor unit 300 is held in a neutral state, and accordingly, also the directional control valve 200 is held in a neutral state. As a result, the pair of cylinder actuators C1 and C2 maintains the current state without operating to extend and retract, and thus the vehicle 100 continues a straight-ahead movement.

When the steering handle 330 is manipulated, a pilot flow rate corresponding to the manipulation amount is applied to the directional control valve 200 and the valve driving unit 230 through the pilot-pressure-supply oil passage 9a or 9b according to a manipulated direction.

Assuming here that the pilot flow rate is supplied to the directional control valve 200 and the valve driving unit 230 from the steering motor unit 300 through the first pilot-pressure-supply oil passage 9a, for example, the pilot flow rate acts as a pilot pressure on the first pilot-pressure chamber 231a, and acts as a pilot pressure on the second pilot-pressure chamber 231b through the first short-circuit oil passage 220. The pilot flow rate is then drained through the second pilot-pressure-supply oil passage 9b into the oil tank 500.

In this example, the pilot pressure acting through the first short-circuit oil passage 220 on the second pilot-pressure chamber 231b is smaller than the pilot pressure acting on the first pilot-pressure chamber 231a. As a result, due to a difference between the pilot pressure acting through the first pilot-pressure chamber 231a on the pilot-pressure receiving surface 208a and that acting through the second pilot-pressure chamber 231b on the pilot-pressure receiving surface 208b, the spool 205 starts moving to the right relative to the sleeve 201 in FIG. 1. When the spool 205 starts moving relative to the sleeve 201, the communicative notch 218a located on the left side of the spool 205 establishes communication with the communication port 215a at a time point when the movement amount reaches a previously set value. Thus, the first pilot-pressure chamber 231a and the second pilot-pressure chamber 231b establish communication therebetween through the communicative notch 218a, the communication port 215a, and the second short-circuit oil passage 216, and as a result, the flow rate of the pressure oil that has passed through the second short-circuit oil passage 216 increases. This further enlarges the difference between the pilot pressure acting through the first pilot-pressure chamber 231a on the pilot-pressure receiving surface 208a and that acting through the second pilot-pressure chamber 231b on the pilot-pressure receiving surface 208b, and thereby, also the movement amount in the same direction of the spool 205 relative to the sleeve 201 is increased.

When the spool 205 is moved to the right relative to the sleeve 201 in FIG. 1, the first actuator port 202a and the input port 203 establish communication with each other by the first communication oil groove 205a and the second communication oil groove 205b of the spool 205, as described above. At the same time, by the third communication oil groove 205c of the spool 205, the second actuator port 202b and the second drain port 204b establish communication with each other. Accordingly, the pressure oils are supplied from the steering pump 400 through the first actuator port 202a and the first connection oil passage 1 to the rod-side pressure chamber of the first cylinder actuator C1 and the head-side pressure chamber of the second cylinder actuator C2, respectively. As a result, the first cylinder actuator C1 operates to degenerate whereas the second cylinder actuator C2 operates to expand. This brings the forward vehicle-body unit 110 in a state bent to the left relative to the backward vehicle-body unit 120, for example. In this way, the vehicle 100 can be moved to the left.

During the operation described above, the controller 700 is in a state of monitoring the displacement of the steering handle 330 through the handle angular sensor 701, as shown in FIG. 5 (Step S101). When it is detected by the handle angular sensor 701 that the steering handle 330 is manipulated from this state (YES at Step S101), the controller 700 obtains a current vehicle body angle through the vehicle-body angular sensor 702 (Step S102), and further compares the obtained vehicle body angle and the vehicle body angle corresponding to the handle angle previously stored in the memory to calculate the knob displacement (Step S103).

When the amount of knob displacement calculated at Step S103 is out of an acceptable range previously set, that is, when the vehicle body angle between the forward vehicle-body unit 110 and the backward vehicle-body unit 120 is displaced beyond the acceptable range relative to the manipulation amount of the steering handle 330 (YET at Step S104), the controller 700 calculates a correction amount of the spool 205 to render the amount of knob displacement zero (Step S105). The controller 700 further transmits a correction-pilot-pressure output command signal to the corresponding electromagnetic valve unit 600a or 600b to move the spool 205 according to the calculated correction amount (Step S106).

As a result, from the electromagnetic valve unit 600a or 600b to which a command signal is given, the correction pilot pressure is applied to the correction-pilot-pressure chamber 232a or 232b, and according thereto, the spool 205 of the directional control valve 200 is moved. At this time, when the vehicle body angle is smaller than the manipulation amount of the steering handle 330, the correction pilot pressure is applied from the electromagnetic valve unit 600a or 600b in the same direction as that of the pilot pressure so that the pilot pressure from the steering motor unit 300 is increased. When the vehicle body angle is larger than the manipulation amount of the steering handle 330, the correction pilot pressure that flows in a direction opposite to that of the pilot pressure is applied from the electromagnetic valve unit 600a or 600b so that the pilot pressure from the steering motor unit 300 is decreased. Accordingly, even when the vehicle body angle is either larger or smaller than the manipulation amount of the steering handle 330, the manner of supplying the pressure oil to the cylinder actuators C1 and C2 is changed so that the vehicle body angle formed between the forward vehicle-body unit 110 and the backward vehicle-body unit 120 is corrected to an appropriate angle corresponding to the manipulation amount of the steering handle 330. This significantly improves the operability of the vehicle 100.

When the amount of knob displacement calculated at Step S103 is within the acceptable range previously set, that is, when the forward vehicle-body unit 110 and the backward vehicle-body unit 120 form a bend based on the manipulation amount of the steering handle 330 (NO at Step S104), the controller 700 ends the current process without performing the succeeding processes, and causes the procedure to return. As a result, in the steering system, the directional control valve 200 is operated according to the pilot pressure supplied from the steering motor unit 300, and further, the cylinder actuators C1 and C2 are operated by the pressure oil supplied and controlled by the directional control valve 200. Accordingly, in this case also, the vehicle 100 is steered based on the manipulation amount of the steering handle 330.

In the embodiment described above, the manipulation amount of the steering handle 330 detected by the handle angular sensor 701 is compared with the vehicle body angle detected by the vehicle-body angular sensor 702. However, the present invention is not limited thereto. For example, the correction pilot pressure can be set by arranging a stroke sensor 800 that detects the movement amount of the spool 205 relative to the sleeve 201 in the directional control valve 200, and comparing the manipulation amount of the steering handle 330 detected by the handle angular sensor 701 with the movement amount of the spool 205 detected by the stroke sensor 800.

In the embodiment described above, the cylinder actuator is exemplified as the steering actuator. However, the cylinder actuator is not necessarily needed.

Moreover, in the embodiment described above, the steering system applied to the construction machine is exemplified. However, the present invention can be also applied to other vehicles. In this case, the present invention is not limited to the vehicle that is steered by forming a bend with the forward vehicle-body unit and the backward vehicle-body unit. That is, it is possible to achieve identical operational effects also in a case that the present invention is applied to a steering system configured such that an orientation of steered wheels is changed relative to the vehicle.

### INDUSTRIAL APPLICABILITY

As described above, the present invention is useful for a steering system of a vehicle such as a construction machine, and enables to operate the directional control valve by supplying the correction pilot pressures from the electromagnetic valve units. Thus, when the operation of the steering actuator is smaller or later than the manipulation of the steering handle, this can be corrected by supplying the correction pilot pressure in the same direction as that of the pilot pressure. When the operation of the steering actuator is larger or earlier, this can be corrected by supplying the correction pilot pressure in a direction opposite to that of the pilot pressure. As a result, it becomes possible to drive the steering actuator based on the manipulation of the steering handle, thereby enabling improvement of the operability of the applied vehicle.

1. A steering system with a directional control valve switchingly operating based on a pilot flow rate supplied from a steering motor unit when a steering handle is manipulated, that steers a vehicle according to a manipulation of the steering handle by controlling a supply of pressure oil to a steering actuator through the directional control valve, the steering system comprising
an electromagnetic valve means that supplies a correction pilot pressure to the directional control valve so as to correct a pilot pressure generated by the pilot flow rate from the steering motor unit when a command signal is given.

2. The steering system according to claim 1, wherein
the steering actuator is a cylinder actuator that operates to extend or retract according to a direction of the pressure oil supply,
the directional control valve includes a spool being disposed movably relative to a sleeve and changes the direction of the pressure oil supply to the steering actuator according to a movement direction of the spool, and
the spool includes a pilot-pressure receiving surface on which the pilot pressure generated by the pilot flow rate from the steering motor unit is applied, and a correction-pilot-pressure receiving surface on which the correction pilot pressure from the electromagnetic valve means is applied.
